(19) United States
(12) Patent Application Publication
(10) Pub. No.: US 2024/0327675 A1
(43) Pub. Date: Oct. 3, 2024

(54) POLISHING COMPOSITIONS AND METHODS OF USE THEREOF

(71) Applicant: Fujifilm Electronic Materials U.S.A., Inc., N.Kingstown, RI (US)

(72) Inventors: Hanyu Fan, Chandler, AZ (US); Bin Hu, Chandler, AZ (US); Yannan Liang, Gilbert, AZ (US); Ting-Kai Huang, Tainan City (TW); Eric Turner, Phoenix, AZ (US)

(21) Appl. No.: 18/616,347

(22) Filed: Mar. 26, 2024

Related U.S. Application Data
(60) Provisional application No. 63/493,542, filed on Mar. 31, 2023.

(51) Int. Cl. C09G 1/02

(52) U.S. Cl. CPC C09G 1/02

(57) ABSTRACT

This disclosure relates to a polishing composition that includes an abrasive; at least one Si-containing compound including an acidic group, an ester thereof, or a salt thereof; and water. This disclosure also features a method of using the polishing composition to polish a substrate.

### CROSS-REFERENCE TO RELATED APPLICATION

The present application claims priority to U.S. Provisional Application Ser. No. 63/493,542, filed on Mar. 31, 2023, the contents of which are hereby incorporated by reference in their entirety.

### BACKGROUND

The semiconductor industry is continually driven to improve chip performance by further miniaturization of devices through process and integration innovations. Chemical Mechanical Polishing/Planarization (CMP) is a powerful technology as it makes many complex integration schemes at the transistor level possible, thereby facilitating increased chip density.

CMP is a process used to planarize/flatten a wafer surface by removing material using abrasion-based physical processes concurrently with surface-based chemical reactions. In general, a CMP process involves applying a CMP slurry (e.g., an aqueous chemical formulation) to a wafer surface while contacting the wafer surface with a polishing pad and moving the polishing pad in relation to the wafer. Slurries typically include an abrasive component and dissolved chemical components, which can vary significantly depending upon the materials (e.g., metals, metal oxides, metal nitrides, dielectric materials such as silicon oxide, silicon nitride, etc.) present on the wafer that will be interacting with the slurry and the polishing pad during the CMP process.

Many currently available CMP slurries were specifically designed to remove materials more common in older chip designs. However, chip designs and architectures are constantly changing and certain components in these older CMP slurries may cause deleterious and/or unacceptable defect counts.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

As defined herein, unless otherwise noted, all percentages expressed should be understood to be percentages by weight to the total weight of the chemical mechanical polishing composition.

In one aspect, the present disclosure features a polishing composition that includes at least one abrasive; at least one first Si-containing compound, the at least one Si-containing compound containing an acidic group, an ester thereof, or a salt thereof; and water; in which the at least one first Si-containing compound is not covalently bonded to the at least one abrasive.

In another aspect, to the present disclosure features a method of polishing a substrate, the method including the steps of: applying a polishing composition described herein to a surface of a substrate; and bringing a pad into contact with the surface of the substrate and moving the pad in relation to the substrate.

In yet another aspect, the present disclosure features a method of stabilizing a polishing composition, the method including mixing the polishing composition with at least one Si-containing compound, in which the polishing composition includes an abrasive and the at least one Si-containing compound includes an acidic group, an ester thereof, or a salt thereof.

Other aspects and advantages of the claimed subject matter will be apparent from the following description and the appended claims.

### DETAILED DESCRIPTION

Embodiments disclosed herein relate generally to compositions and methods of using said compositions to polish semiconductor substrates (e.g., wafers) that may include at least a copper portion and, more specifically, may include at least silicon oxide and copper portions. In some embodiments, it is desirable to remove the copper at a removal rate that is greater than half of the silicon oxide removal rate. The present inventors surprisingly discovered that the compositions disclosed herein can effectively reduce residues on the polished substrate surfaces, while still effectively maintaining the desired removal rate ratio between copper and silicon oxide. For example, the compositions disclosed herein can be particularly useful for polishing advanced node films that include copper, a ruthenium liner, barrier (e.g., Ta, TaN) and dielectric materials (e.g., TEOS, low-k, ultra low-k, etc.)

In one or more embodiments, the polishing composition described herein includes at least one abrasive, at least one first Si-containing compound, and water, wherein at least a portion (e.g., substantially all) of the at least one first Si-containing compound is not covalently bonded to the at least one abrasive. In one or more embodiments, a polishing composition according to the present disclosure can include from about 0.1% to about 50% by weight abrasive, about 0.0001% to about 20% by weight first Si-containing compound, and the remaining percent by weight (e.g., from about 30% to about 99.9% by weight) of solvent (e.g., deionized water). Optionally, the polishing composition described herein can include at least one organic acid in an amount of from about 0.02% to about 4% by weight of the composition, at least one low-k removal rate inhibitor in an amount of from about 0.005% to about 5% by weight of the composition, at least one azole-containing corrosion inhibitor in an amount of from about 0.0001% to about 1% by weight of the composition, and/or at least one pH adjuster in an amount of from about 0.05% to about 10% by weight of the composition.

In one or more embodiments, the present disclosure provides a concentrated polishing composition that can be diluted with water prior to use by up to a factor of two, or up to a factor of four, or up to a factor of six, or up to a factor of eight, or up to a factor of ten. In other embodiments, the present disclosure provides a point-of-use (POU) polishing composition comprising the above-described polishing composition, water, and optionally an oxidizer for use on a substrate (e.g., a substrate containing copper and a silicon oxide).

In one or more embodiments, a POU polishing composition can include from about 0.1% to about 12% by weight of abrasive, optionally about 0.02% to about 1% by weight of organic acid, about 0.0001% to about 10% by weight of first Si-containing compound, optionally about 0.1% to about 5% by weight of oxidizer, and about 84% to about 99% by weight of solvent (e.g., deionized water). Further, the polishing composition described herein can optionally include at least one low-k removal rate inhibitor in an amount of from about 0.005% to about 1% by weight of the composition, at least one azole-containing corrosion inhibitor in an amount of from about 0.0001% to about 0.5% by weight of the composition, and/or at least one pH adjuster in an amount of from about 0.05% to about 5% by weight of the composition.

In one or more embodiments, a concentrated polishing composition can include from about 1% to about 50% by weight of abrasive, optionally about 0.2% to about 4% by weight of organic acid, about 0.001% to about 20% by weight of first Si-containing compound, and the remaining percent by weight (e.g., from about 26% to about 99% by weight) of solvent (e.g., deionized water). Optionally, the polishing composition described herein can include at least one low-k removal rate inhibitor in an amount of from about 0.05% to about 5% by weight of the composition, at least one azole-containing corrosion inhibitor in an amount of from about 0.001% to about 1% by weight of the composition, and/or at least one pH adjuster in an amount of from about 0.5% to about 10% by weight of the composition.

In one or more embodiments, the polishing composition described herein can include at least one (e.g., two or three) abrasive. In some embodiments, the at least one abrasive is selected from the group consisting of cationic abrasives, substantially neutral abrasives, and anionic abrasives. In one or more embodiments, the at least one abrasive is selected from the group consisting of alumina, silica, titania, ceria, zirconia, co-formed products thereof (i.e., co-formed products of alumina, silica, titania, ceria, or zirconia), coated abrasives, surface modified abrasives, and mixtures thereof. In some embodiments, the at least one abrasive does not include ceria or an abrasive surface modified by a Si-containing compound. In some embodiments, the at least one abrasive is of high-purity, and can have less than about 100 ppm of alcohol, less than about 100 ppm of ammonia, and less than about 100 parts per billion (ppb) of an alkali cation such as sodium cation. The abrasive can be present in an amount of from about 0.1% to about 12% (e.g., from about 0.5% to about 10%), based on the total weight of the POU polishing composition, or any subranges thereof.

In some embodiments, the at least one abrasive is in an amount of from at least about 0.1% (e.g., at least about 0.5%, at least about 1%, at least about 2%, at least about 4%, at least about 5%, at least about 10%, at least about 12%, at least about 15%, or at least about 20%) by weight to at most about 50% (e.g., at most about 45%, at most about 40%, at most about 35%, at most about 30%, at most about 25%, at most about 20%, at most about 15%, at most about 12%, at most about 10%, or at most about 5%) by weight of the polishing composition described herein.

In one or more embodiments, the at least one abrasive can have a mean particle size of from at least about 1 nm (e.g., at least about 5 nm, at least about 10 nm, at least about 20 nm, at least about 40 nm, at least about 50 nm, at least about 60 nm, at least about 80 nm, or at least about 100 nm) to at most about 1000 nm (e.g., at most about 800 nm, at most about 600 nm, at most about 500 nm, at most about 400 nm, at most about 200 nm, at most about 150 nm, or at most about 100 nm). As used herein, the mean particle size (MPS) is determined by dynamic light scattering techniques.

In one or more embodiments, the polishing composition described herein can include at least one (e.g., two or three) first Si-containing compound. In one or more embodiments, the at least one first Si-containing compound includes at least one acidic group, an ester thereof, or a salt thereof. In one or more embodiments, the acidic groups on the Si-containing compound are chemically distinct. In one or more embodiments, the first Si-containing compound includes a carboxylic acid group, an ester thereof, or a salt thereof (e.g., a carboxylate group); a sulfonic acid group, an ester thereof, or a salt thereof (e.g., a sulfonate group); or a phosphonic acid group, an ester thereof, or a salt thereof (e.g., a phosphonate group). In one or more embodiments, the at least one first Si-containing is selected from the group consisting of 3-(trihydroxysilyl)propyl methylphosphonate, 3-(trihydroxysilyl)-1-propanesulfonic acid, carboxyethylsilanetriol, (2-diethylphosphatoethyl)triethoxysilane, [3-(trihydroxysilyl)propyl](methyl)phosphate, 3-(trimethylsilyl)-1-propanesulfonic acid, 3-{[dimethyl(3-trimethoxysilyl)propyl]ammonio}-propane-1-sulfonate, salts thereof, or combinations thereof. In general, at least a portion (e.g., substantially all) of the at least one Si-containing compound is not covalently bonded to the at least one abrasive. In some non-limiting embodiments, the at least one first Si-containing compound includes (1) at least one acidic group, an ester thereof, or a salt thereof (e.g., any described herein) and (2) at least one alkoxy group (e.g., —OR, in which R is linear or branched alkyl that may be substituted or unsubstituted and that may be cyclic or acyclic), alkyl group (e.g., —R, in which R is linear or branched alkyl that may be substituted or unsubstituted and that may be cyclic or acyclic), hydroxyl group (e.g., —OH or a salt thereof), hydrogen (e.g., —H), halo group (e.g., —X, in which X is fluoro, chloro, bromo, or iodo), or a combination of any of these.

In one or more embodiments, the at least one first Si-containing compound is in an amount from about 0.0001% to 20% by weight of the polishing composition. For example, the at least one first Si-containing compound can be at least about 0.0001% (e.g., at least about 0.0005%, at least about 0.001%, at least about 0.005%, at least about 0.01%, at least about 0.05%, at least about 0.1%, at least about 0.5%, at least about 1%, at least about 2.5%, or at least about 3%) by weight to at most about 20% (e.g., at most about 15%, at most about 12.5%, at most about 10%, at most about 7.5%, at most about 5%, at most about 2.5%, or at most about 1%) by weight of the polishing composition described herein.

Without wishing to be bound by theory, the inventors surprisingly discovered that the first Si-containing compound can (1) stabilize the abrasive in the polishing composition, thereby extending the shelf life of the polishing composition and/or (2) provide for reduced defect counts on polished surfaces.

In one or more embodiments, the polishing composition described herein can optionally further include at least one (e.g., two or three) second Si-containing compound different from the first Si-containing compound. In some embodiments, the second Si-containing compound does not include an acidic group, an ester thereof, or a salt thereof. In one or more embodiments, the second Si-containing compound can be a tetraalkyl orthosilicate. In some embodiments, the second Si-containing compound can be selected from the group consisting of tetramethyl orthosilicate (TMOS), tetraethyl orthosilicate (TEOS), potassium methylsiliconate, (3-glycidyloxypropyl)trimethoxy-silane, triethoxysilylpropoxy(polyethyleneoxy)dodecanoate, (3-triethoxysilyl)propylsuccinic anhydride, N-(2-aminoethyl)-3-aminopropyl-trimethoxysilane, ureidopropyltriethoxysilane, trimethylmethoxysilane, N-trimethoxysilylpropyl-N,N,N-trimethylammonium chloride, dimethyldimethoxysilane, vinyltrimethoxysilane, and potassium silicate.

In one or more embodiments, the at least one second Si-containing compound can be from at least about 0.0001% (e.g., at least about 0.0005%, at least about 0.001%, at least about 0.005%, at least about 0.01%, at least about 0.05%, at least about 0.1%, at least about 0.5%, at least about 1%, at least about 2.5%, or at least about 3%) by weight to at most about 10% (e.g., at most about 8%, at most about 6%, at most about 5%, at most about 4%, at most about 2%, or at most about 1%) by weight of the polishing composition described herein.

Without wishing to be bound by theory, the inventors surprisingly discovered that the second Si-containing compound can reduce corrosion of certain materials (e.g., Cu) in a semiconductor substrate when the substrate is polished by the polishing composition described herein.

In general, the first and second Si-containing compounds are dissolved or solubilized in the polishing composition described herein and are not dispersed or suspended in the polishing composition (e.g., in the form of particles or droplets).

In one or more embodiments, the polishing composition described herein can optionally include at least one (e.g., two or three) pH adjuster. In one or more embodiments, the at least one pH adjuster is selected from inorganic bases, organic bases, and mixtures thereof. In some embodiments, the inorganic base can be selected from the group consisting of ammonium hydroxide, sodium hydroxide, potassium hydroxide, cesium hydroxide, rubidium hydroxide, and any combinations thereof. In one or more embodiments, the organic base is a quaternary ammonium hydroxide (e.g., an alkylammonium hydroxide such as a tetraalkylammonium hydroxide) or a quaternary phosphonium hydroxide (e.g., an alkylphosphonium hydroxide such as a tetraalkylphosphonium hydroxide). In one or more embodiments, the quaternary ammonium hydroxide is selected from the group consisting of tetrabutylammonium hydroxide, ethyltrimethylammonium hydroxide, tetrapropylammonium hydroxide, tetraethylammonium hydroxide, tetramethylammonium hydroxide, diethyldimethylammonium hydroxide, dimethyldipropylammonium hydroxide, benzyltrimethylammonium hydroxide, and any combinations thereof. In one or more embodiments, the quaternary phosphonium hydroxide is selected from the group consisting of tetramethylphosphonium hydroxide, tetraethylphosphonium hydroxide, tetrapropylphosphonium hydroxide, tetrabutylphosphonium hydroxide, tetrapentylphosphonium hydroxide, tricthylmethylphosphonium hydroxide, tetrakis(hydroxymethyl)phosphonium hydroxide, tetraphenylphosphonium hydroxide, and any combinations thereof. In one or more embodiments, the quaternary ammonium hydroxide or quaternary phosphonium hydroxide does not include covalently bound hydroxyl groups (e.g., does not include choline hydroxide or tris(2-hydroxyethyl)methylammonium hydroxide).

In one or more embodiments, the polishing composition optionally includes an organic base that does not include a quaternary ammonium hydroxide or quaternary phosphonium hydroxide. In one or more embodiments, the organic base that does not include a quaternary ammonium hydroxide or quaternary phosphonium hydroxide is selected from the group consisting of alkylamines, aminoalcohols, guanidines, cyclic amines, and mixtures thereof. In one or more embodiments, the organic base that does not include a quaternary ammonium hydroxide or quaternary phosphonium hydroxide is selected from the group consisting of monomethylamine, dimethylamine, trimethylamine, monocthylamine, diethylamine, (triethyl)amine, monopropylamine, dipropylamine, tri-n-propylamine, monobutylamine, dibutylamine, tributylamine, isopropylamine, ethanolamine, diethanolamine, triethanolamine, 2-amino-2-methyl-1-propanol, 2-amino-2-methyl-1,3-propanediol, 2-dimethylamino-2-methylpropanol, tris(hydroxymethyl)aminomethane, 2-amino-2-ethyl-1,3-propanediol, 3-amino-4-octanol, aminopropyldiethanolamine, 2-[(3-aminopropyl)methylamino]ethanol, 2-(2-aminoethoxy)ethanol, 2-(3-aminopropylamino)ethanol, 2-dimethylaminoethanol, cysteamine, 1,3-diphenylguanidine, 1,1,3,3-tetramethylguanidine, 1,2,3-triphenylguanidine, 1-(tert-butoxycarbonyl)guanidine, creatinol phosphate, N-tosyl-L-arginine, 1,3-di-o-tolylguanidine, 1,8-diazabicyclo[2,2.2]octane, 1,8-diazabicyclo [4.3.0]non-5-ene, 1,8-diazabicyclo [5.4.0]undec-7-ene, and mixtures thereof.

In one or more embodiments, the amount of the pH adjusters (e.g., the at least one inorganic base and the at least one organic base (e.g., including an optional second organic base)) is from at least about 0.05% (e.g., at least about 0.1%, at least about 0.2%, at least about 0.4%, at least about 0.5%, at least about 0.8%, at least about 1%, at least about 2%, at least about 5%, or at least about 7%) by weight to at most about 10% (e.g., at most about 9%, at most about 8%, at most about 7%, at most about 6%, at most about 5%, at most about 4%, at most about 3%, at most about 2%, at most about 1%, at most about 0.5%, at most about 0.2%, or at most about 0.1%) by weight of the polishing composition described herein.

In one or more embodiments, the pH value of the polishing composition can range from at least about 2 (e.g., at least about 2.5, at least about 3, at least about 3.5, at least about 4, at least about 4.5, at least about 5, at least about 5.5, at least about 6, at least about 6.5, at least about 7, at least about 7.5, at least about 8, at least about 8.5, at least about 9, at least about 9.5, at least about 10, at least about 10.5, at least about 11, at least about 11.5, or at least about 12) to at most about 14 (e.g., at most about 13.5, at most about 13, at most about 12.5, at most about 12, at most about 11.5, at most about 11, at least about 10.5, at most about 10, at most about 9.5, at most about 9, at most about 8.5, at most about 8, at most about 7.5, at most about 7, at most about 6.5, at most about 6, at most about 5.5, at most about 5, or at most about 4.5). In one or more embodiments, the pH value of the polishing composition may be alkaline (i.e., greater than 7). Without wishing to be bound by theory, it is believed that a polishing composition having a pH lower than 2 would significantly increase corrosion and particle residues, and a polishing composition having a pH higher than 14 can affect the stability of the suspended abrasive and would significantly increase the roughness and decrease the overall quality of a film polished by such a composition. To obtain the desired pH, the relative concentrations of the ingredients in the polishing compositions described herein can be adjusted.

In one or more embodiments, the polishing composition described herein can optionally include at least one (e.g., two or three) organic acid or a salt thereof. In some embodiments, the at least one organic acid is selected from a carboxylic acid, an amino acid, a sulfonic acid, a phosphoric acid, or a phosphonic acid or a salt thereof. In some embodiments, the organic acid or a salt thereof is selected from the group consisting of gluconic acid, lactic acid, citric acid, tartaric acid, malic acid, glycolic acid, malonic acid, formic acid, oxalic acid, acetic acid, propionic acid, peracetic acid, succinic acid, potassium acetate, potassium citrate, amino acetic acid, phenoxyacetic acid, bicine, diglycolic acid, glyceric acid, tricine, alanine, histidine, valine, phenylalanine, proline, glutamine, aspartic acid, glutamic acid, arginine, lysine, tyrosine, benzoic acid, 1,2-cthanedisulfonic acid, 4-amino-3-hydroxy-1-naphthalenesulfonic acid, 8-hydroxyquinoline-5-sulfonic acid, aminomethanesulfonic acid, benzenesulfonic acid, hydroxylamine O-sulfonic acid, methanesulfonic acid, m-xylene-4-sulfonic acid, poly (4-styrenesulfonic acid), polyanetholesulfonic acid, p-toluenesulfonic acid, trifluoromethane-sulfonic acid, ethyl phosphoric acid, cyanoethyl phosphoric acid, phenyl phosphoric acid, vinyl phosphoric acid, vinyl phosphonic acid, poly (vinylphosphonic acid), 1-hydroxyethane-1,1-diphosphonic acid, nitrilotri (methylphosphonic acid), diethylenetriaminepentakis (methylphosphonic acid), N,N,N′,N′-ethylenediaminetetrakis (methylene phosphonic acid), n-hexylphosphonic acid, benzylphosphonic acid, phenylphosphonic acid, ethylenediaminetetraacetic acid, iminodiacetic acid, N-hydroxyethyl-ethylenediaminetriacetic acid, nitrilotriacetic acid, diethylenetriaminepentaacetic acid, hydroxyethylethylenediaminetriacetic acid, triethylenetetraaminehexaacetic acid, diaminocyclohexanetetraacetic acid, nitrilotrimethylphosphonic acid, ethylenediaminetetra (methylenephosphonic acid), 1-hydroxyl ethylidene-1,1,-diphosphonic acid, diethylenetriamine penta (methylene phosphonic acid), salts thereof, and mixtures thereof.

In one or more embodiments, the at least one organic acid is in an amount of from at least about 0.02% (e.g., at least about 0.05%, at least about 0.1%, at least about 0.2%, at least about 0.4%, at least about 0.5%, at least about 0.6%, at least about 0.8%, at least about 1%, at least about 1.5%, or at least about 2%) by weight to at most about 4% (e.g., at most about 3.5%, at most about 3%, at most about 2.5%, at most about 2%, at most about 1.5%, or at most about 1%) by weight of the polishing composition described herein.

In one or more embodiments, the polishing composition described herein can optionally include at least one (e.g., two or three) low-k removal rate inhibitor. In some embodiments, the at least one low-k removal rate inhibitor is a nonionic surfactant. In some embodiments, the nonionic surfactant is the only low-k removal rate inhibitor in the polishing composition. In one or more embodiments, the nonionic surfactant is selected from the group consisting of alcohol alkoxylates, alkylphenol alkoxylates, tristyrylphenol alkoxylates, sorbitan ester alkoxylates, polyalkoxylates, polyalkylene oxide block copolymers, alkoxylated diamines, and mixtures thereof. In one or more embodiments, the nonionic surfactant is a polymer having a number average molecular weight of at least about 1,000 g/mol (e.g., at least about 2,500 g/mol, at least about 5,000 g/mol, at least about 7,500 g/mol, or at least about 10,000 g/mol). In one or more embodiments, the nonionic surfactant is a polymer having a number average molecular weight of at most about 1,000,000 g/mol (e.g., at most about 750,000 g/mol, at most about 500,000 g/mol, at most about 250,000 g/mol, or at most about 100,000 g/mol). In one or more embodiments, the alkoxylate groups of the alkoxylated nonionic surfactants are ethoxylate, propoxylate, or a combination of ethoxylate and propoxylate groups. Without wishing to be bound by theory, it is surprising that a nonionic surfactant (such as those described above) can be used as a low-k removal rate inhibitor in the polishing composition described herein to reduce or minimize the removal rate of a low-k film (e.g., a carbon doped silicon oxide film or a silicon oxycarbide film) in a semiconductor substrate. In some embodiments, the polishing composition described herein does not include alkylphenol alkoxylates.

In some embodiments, the at least one low-k removal rate inhibitor is in an amount of from at least about 0.005% (e.g., at least about 0.01%, at least about 0.05%, at least about 0.1%, at least about 0.5%, at least about 1%, at least about 1.5%, at least about 2%, or at least about 3%) by weight to at most about 5% (e.g., at most about 4.5%, at most about 4%, at most about 3.5%, at most about 3%, at most about 2.5%, at most about 2%, at most about 1.5%, at most about 1%, at most about 0.5%, or at most about 0.1%) by weight of the polishing composition described herein.

In one or more embodiments, the polishing composition described herein can optionally include at least one (e.g., two or three) azole-containing corrosion inhibitor. In some embodiments, the at least one azole-containing corrosion inhibitor is selected from the group consisting of substituted or unsubstituted triazoles, substituted or unsubstituted tetrazoles, substituted or unsubstituted benzotriazoles, substituted or unsubstituted pyrazoles, substituted or unsubstituted imidazoles, substituted or unsubstituted benzimidazoles, substituted or unsubstituted thiadiazoles, substituted or unsubstituted thiabendazole, substituted or unsubstituted adenines, substituted or unsubstituted xanthines, and substituted or unsubstituted guanines. In one or more embodiments, the azole-containing corrosion inhibitor can be selected from the group consisting of 1,2,4-triazole, 1,2,3-triazole, tetrazole, benzotriazole, tolyltriazole, methyl benzotriazole (e.g., 1-methyl benzotriazole, 4-methyl benzotriazole, or 5-methyl benzotriazole), ethyl benzotriazole (e.g., 1-ethyl benzotriazole), propyl benzotriazole (e.g., 1-propyl benzotriazole), butyl benzotriazole (e.g., 1-butyl benzotriazole or 5-butyl benzotriazole), pentyl benzotriazole (e.g., 1-pentyl benzotriazole), hexyl benzotriazole (e.g., 1-hexyl benzotriazole or 5-hexyl benzotriazole), dimethyl benzotriazole (e.g., 5,6-dimethyl benzotriazole), chloro benzotriazole (e.g., 5-chloro benzotriazole), dichloro benzotriazole (e.g., 5,6-dichloro benzotriazole), chloromethyl benzotriazole (e.g., 1-(chloromethyl)-1-H-benzotriazole), chloroethyl benzotriazole, phenyl benzotriazole, benzyl benzotriazole, aminotriazole, aminobenzimidazole, aminotetrazole, pyrazole, imidazole, adenine, xanthine, guanine, benzimidazole, thiabendazole, 1-hydroxybenzotriazole, 2-methylbenzothiazole, 2-aminobenzimidazole, 2-amino-5-ethyl-1,3,4-thiadiazole, 3,5-diamino-1,2,4-triazole, 3-amino-5-methylpyrazole, 4-amino-4H-1,2,4-triazole, and mixtures thereof. Without wishing to be bound by theory, it is believed that an azole-containing corrosion inhibitor (such as those described above) can significantly reduce or minimize the corrosion and removal rate of metals (e.g., copper) in a semiconductor substrate.

In some embodiments, the at least one azole-containing corrosion inhibitor is in an amount of from at least about 0.0001% (e.g., at least about 0.0002%, at least about 0.0005%, at least about 0.001%, at least about 0.002%, at least about 0.005%, at least about 0.01%, at least about 0.02%, at least about 0.05%, at least about 0.1%, at least about 0.2%, or at least about 0.5%) by weight to at most about 1% (e.g., at most about 0.8%, at most about 0.6%, at most about 0.5%, at most about 0.4%, at most about 0.2%, at most about 0.1%, at most about 0.05%, at most about 0.02%, at most about 0.01%, or at most about 0.005%) by weight of the polishing composition described herein.

In one or more embodiments, the polishing composition described herein can optionally include at least one (e.g., two or three) oxidizer. In some embodiments, an oxidizer can be added when diluting a concentrated slurry to form a POU slurry. The oxidizer can be selected from the group consisting of hydrogen peroxide, ammonium persulfate, silver nitrate (AgNO₃), ferric nitrates or chlorides, per acids or salts, ozone water, potassium ferricyanide, potassium dichromate, potassium iodate, potassium bromate, potassium periodate, periodic acid, vanadium trioxide, hypochlorous acid, sodium hypochlorite, potassium hypochlorite, calcium hypochlorite, magnesium hypochlorite, ferric nitrate, potassium permanganate, other inorganic or organic peroxides, and mixtures thereof. In some embodiments, the oxidizer is hydrogen peroxide.

In some embodiments, the oxidizer is in an amount of from at least about 0.05% (e.g., at least about 0.1%, at least about 0.2%, at least about 0.4%, at least about 0.5%, at least about 1%, at least about 1.5%, at least about 2%, at least about 2.5%, at least about 3%, at least about 3.5%, at least about 4%, or at least about 4.5%) by weight to at most about 5% (e.g., at most about 4.5%, at most about 4%, at most about 3.5%, at most about 3%, at most about 2.5%, at most about 2%, at most about 1.5%, at most about 1%, at most about 0.5%, or at most about 0.1%) by weight of the polishing composition described herein. In some embodiments, without wishing to be bound by theory, it is believed that the oxidizer can help remove metal films by forming a metal complex with a chelating agent so that the metal can be removed during the CMP process. In some embodiments, without wishing to be bound by theory, it is believed that the metal complex formed between a metal film and an oxidizer can form a passivation layer, which can protect the metal from corrosion. In some embodiments, the oxidizer may reduce the shelf life of a polishing composition. In such embodiments, the oxidizer can be added to the polishing composition at the point of use right before polishing.

In one or more embodiments, the polishing composition described herein can optionally include at least one (e.g., two or three) nitride removal rate reducing agent. In some embodiments, the nitride removal rate reducing agent is a compound that includes a hydrophobic portion containing a C₄ to C₄₀ hydrocarbon group (e.g., containing an alkyl group and/or an alkenyl group); and a hydrophilic portion containing at least one group selected from the group consisting of a sulfinite group, a sulfate group, a sulfonate group, a carboxylate group, a phosphate group, and a phosphonate group. In one or more embodiments, the hydrophobic portion and the hydrophilic portion are separated by zero to ten (e.g., 1, 2, 3, 4, 5, 6, 7, 8, or 9) alkylene oxide groups (e.g., —(CH₂)ₙO— groups in which n can be 1, 2, 3, or 4). In one or more embodiments, the nitride removal rate reducing agent has zero alkylene oxide groups separating the hydrophobic portion and the hydrophilic portion. Without wishing to be bound by theory, it is believed that the presence of alkylene oxide groups within the nitride removal rate reducing agent may not be preferred in some embodiments as they may create slurry stability issues and increase silicon nitride removal rate.

In one or more embodiments, the nitride removal rate reducing agent has a hydrophobic portion containing a hydrocarbon group that includes at least 4 carbon atoms (C₄) (e.g., at least 6 carbon atoms (C₆), at least 8 carbon atoms (C₈), at least 10 carbon atoms (C₁₀), at least 12 carbon atoms (C₁₂), at least 14 carbon atoms (C₁₄), at least 16 carbon atoms (C₁₆), at least 18 carbon atoms (C₁₈), at least 20 carbon atoms (C₂₀), or at least 22 carbon atoms (C₂₂)) and/or at most 40 carbon atoms (C₄₀) (e.g., at most 38 carbon atoms (C₃₈), at most 36 carbon atoms (C₃₆), at most 34 carbon atoms (C₃₄), at most 32 carbon atoms (C₃₂), at most 30 carbon atoms (C₃₀), at most 28 carbon atoms (C₂₈), at most 26 carbon atoms (C₂₆), at most 24 carbon atoms (C₂₄), or at most 22 carbon atoms (C₂₂)). The hydrocarbon groups mentioned herein refer to groups that contain only carbon and hydrogen atoms and can include both saturated groups (e.g., linear, branched, or cyclic alkyl groups) and unsaturated groups (e.g., linear, branched, or cyclic alkenyl groups; linear, branched, or cyclic alkynyl groups; or aromatic groups (e.g., phenyl or naphthyl)). In one or more embodiments, the hydrophilic portion of the nitride removal rate reducing agent contains at least one group selected from a phosphate group and a phosphonate group. It is to be noted that the term “phosphonate group” is expressly intended to include phosphonic acid groups.

In one or more embodiments, the nitride removal rate reducing agent is selected from the group consisting of naphthalenesulfonic acid-formalin condensate, lauryl phosphate, myristyl phosphate, stearyl phosphate, octadecylphosphonic acid, oleyl phosphate, behenyl phosphate, octadecyl sulfate, lacceryl phosphate, oleth-3-phosphate, and oleth-10-phosphate, and combinations thereof.

In one or more embodiments, the nitride removal rate reducing agent can be included in a polishing composition described herein in an amount from at least about 0.1 ppm (e.g., at least about 0.5 ppm, at least about 1 ppm, at least about 5 ppm, at least about 10 ppm, at least about 25 ppm, at least about 50 ppm, at least about 75 ppm, or at least about 100 ppm) to at most about 1000 ppm (e.g., at most about 900 ppm, at most about 800 ppm, at most about 700 ppm, at most about 600 ppm, at most about 500 ppm, or at most about 250 ppm) based on the total weight of the composition.

In some embodiments, the polishing composition described herein can include a solvent (e.g., a primary solvent), such as water. In some embodiments, the solvent (e.g., water) is in an amount of from at least about 20% (e.g., at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 92%, at least about 94%, at least about 95%, or at least about 97%) by weight to at most about 99% (e.g., at most about 98%, at most about 96%, at most about 94%, at most about 92%, at most about 90%, at most about 85%, at most about 80%, at most about 75%, at most about 70%, or at most about 65%) by weight of the polishing composition described herein.

In one or more embodiments, an optional secondary solvent (e.g., an organic solvent) can be used in the polishing composition (e.g., the POU or concentrated polishing composition) of the present disclosure, which can help with the dissolution of one or more components in the polishing composition (e.g., the azole-containing corrosion inhibitor). In one or more embodiments, the secondary solvent can be one or more alcohols, alkylene glycols, or alkylene glycol ethers. In one or more embodiments, the secondary solvent includes one or more solvents selected from the group consisting of ethanol, 1-propanol, 2-propanol, n-butanol, propylene glycol, 2-methoxyethanol, 2-ethoxyethanol, propylene glycol propyl ether, and ethylene glycol.

In some embodiments, the secondary solvent is in an amount of from at least about 0.0025% (e.g., at least about 0.005%, at least about 0.01%, at least about 0.02%, at least about 0.05%, at least about 0.1%, at least about 0.2%, at least about 0.4%, at least about 0.6%, at least about 0.8%, or at least about 1%) by weight to at most about 2% (e.g., at most about 1.8%, at most about 1.6%, at most about 1.5%, at most about 1.4%, at most about 1.2%, at most about 1%, at most about 0.8%, at most about 0.6%, at most about 0.5%, or at most about 0.1%) by weight of the polishing composition described herein.

In one or more embodiments, the polishing composition described herein can be substantially free of one or more of certain ingredients, such as organic solvents, pH adjusting agents, quaternary ammonium compounds (e.g., salts such as tetraalkylammonium salts and hydroxides such as tetraalkylammonium hydroxide), alkali bases (such as alkali hydroxides), fluorine-containing compounds (e.g., fluoride compounds or fluorinated compounds (such as fluorinated polymers/surfactants)), silicon-containing compounds such as silanes (e.g., alkoxysilanes, including TEOS and TMOS, in which an alkoxysilane can include a compound that lacks at least one acidic group, an ester thereof, or a salt thereof (e.g., any described herein) or in which an alkoxysilane can include a compound that includes (1) at least one alkyl group (e.g., —R, in which R is linear or branched alkyl that may be substituted or unsubstituted and that may be cyclic or acyclic) and (2) further groups selected from the group consisting of an alkoxy group (e.g., —OR, in which R is linear or branched alkyl that may be substituted or unsubstituted and that may be cyclic or acyclic), alkyl group (e.g., —R, in which R is linear or branched alkyl that may be substituted or unsubstituted and that may be cyclic or acyclic), hydroxyl group (e.g., —OH or a salt thereof), hydrogen (e.g., —H), halo group (e.g., —X, in which X is fluoro, chloro, bromo, or iodo), or a combination of any of these; and aminosilanes, including aminopropyltriethoxysilane, in which an aminosilane can include a compound that lacks at least one acidic group, an ester thereof, or a salt thereof (e.g., any described herein) or in which an aminosilane can include a compound that includes (1) at least one amino group (e.g., —NR^{N1}R^{N2} or —NR^{N1}—, in which each of R^{N1} and R^{N2} is, independently, H or a linear or branched alkyl that may be substituted or unsubstituted and that may be cyclic or acyclic) and (2) further groups selected from the group consisting of an alkoxy group (e.g., —OR, in which R is linear or branched alkyl that may be substituted or unsubstituted and that may be cyclic or acyclic), alkyl group (e.g., —R, in which R is linear or branched alkyl that may be substituted or unsubstituted and that may be cyclic or acyclic), hydroxyl group (e.g., —OH or a salt thereof), hydrogen (e.g., —H), halo group (e.g., —X, in which X is fluoro, chloro, bromo, or iodo), or a combination of any of these), nitrogen containing compounds (e.g., amino acids, amines, imines (e.g., amidines such as 1,8-diazabicyclo [5.4.0]-7-undecene (DBU) and 1,5-diazabicyclo [4.3.0]non-5-ene (DBN)), amides, or imides), polyols, salts (e.g., halide salts or metal salts), polymers (e.g., non-ionic, cationic, anionic, or water-soluble polymers), inorganic acids (e.g., hydrochloric acid, sulfuric acid, phosphoric acid, or nitric acid), surfactants (e.g., cationic surfactants, anionic surfactants, non-polymeric surfactants, or non-ionic surfactants), zwitterionic compounds, plasticizers, oxidizing agents (e.g., hydrogen peroxide and/or periodic acid), corrosion inhibitors (e.g., azole or non-azole corrosion inhibitors), electrolytes (e.g., polyelectrolytes), dienoic acids (e.g., sorbic acid), and/or certain abrasives (e.g., polymeric abrasives, fumed silica, ceria abrasives, non-ionic abrasives, surface modified abrasives, negatively/positively charged abrasives, or ceramic abrasive composites). The halide salts that can be excluded from the polishing compositions include alkali metal halides (e.g., sodium halides or potassium halides) or ammonium halides (e.g., ammonium chloride), and can be fluorides, chlorides, bromides, or iodides. As used herein, an ingredient that is “substantially free” from a polishing composition refers to an ingredient that is not intentionally added into the polishing composition. In some embodiments, the polishing composition described herein can have at most about 1000 ppm (e.g., at most about 500 ppm, at most about 250 ppm, at most about 100 ppm, at most about 50 ppm, at most about 10 ppm, or at most about 1 ppm) of one or more of the above ingredients that are substantially free from the polishing composition. In some embodiments, the polishing compositions described herein can be completely free of one or more of the above ingredients.

In one or more embodiments, the polishing composition described herein can have a ratio of a removal rate for Cu to a removal rate for silicon oxides (e.g., TEOS) (i.e., a removal rate selectivity) of from at least about 0.5:1 (e.g., at least about 0.6:1, at least about 0.7:1, or at least about 0.8:1) to at most about 2:1 (e.g., at most about 1.8:1, at most about 1.6:1, at most about 1.4:1, at most about 1.2:1, or at most about 1:1). It is to be noted that the term “silicon oxide” described herein is expressly intended to include both un-doped and doped versions of silicon oxide. In some embodiments, the silicon oxide can be doped with at least one dopant selected from carbon, nitrogen, oxygen, hydrogen, or any other known dopants for silicon oxide.

Some examples of silicon oxide film types on a semiconductor substrate include TEOS (tetra-ethyl orthosilicate), SiOC, SiOCN, SiOCH, SiOH, and SiON. In one or more embodiments, the ratios and/or removal rates described above can be applicable when measuring removal rates for polishing either blanket wafers or patterned wafers (e.g., wafers including conductive layers, barrier layers, and/or dielectric layers).

In one or more embodiments, the total defect counts on a wafer (e.g., on a copper surface of a wafer) having a diameter of 12 inches (i.e., about 300 mm) is at most 800 (e.g., at most 700, at most 600, at most 500, at most 400, at most 300, at most 250, at most 200, at most 150, at most 100, or at most 50) after polishing the wafer using a polishing composition according to the present disclosure. In one or more embodiments, the defects can result from scratches, organic residues, particle contamination (e.g., abrasive), and combinations thereof. In general, the defects can be counted by using a laser scattering inspection system (e.g., a KLA XUV Advanced Inspection Tool) and then analyzed and classified by reviewing images of the polished wafer taken using a scanning electron microscope (SEM). In one or more embodiments, the defects counted are those at least about 100 nm in size.

The present disclosure also contemplates a method of using any of the above-described polishing compositions (e.g., concentrates or POU slurries). With the concentrate, the method can include the steps of diluting the concentrate to form a POU slurry (e.g., by a factor of at least two), and then contacting a substrate surface at least partially comprising copper with the POU slurry. In some embodiment, an oxidizer can be added to the slurry before or after the dilution. With the POU slurry, the method can include the step of contacting the substrate surface at least partially comprising copper with the polishing composition.

In one or more embodiments, this disclosure features a polishing method that can include applying a polishing composition according to the present disclosure to a surface of a substrate (e.g., a wafer having at least copper and silicon oxide on the surface of the substrate); and bringing a pad into contact with the surface of the substrate and moving the pad in relation to the substrate. Further, in some embodiments, after polishing a substrate with a polishing composition described herein, the polished substrate can undergo a rinse polishing process where a composition including all the components of the polishing composition described herein, except the abrasive, is applied to the polished substrate in the polishing tool and the pad of the polishing tool is brought into contact with the substrate and moved in relation to the substrate to create a rinse polished substrate. In some embodiments, after the polishing process and/or the rinse polishing process, the substrate can be removed from the polishing tool and subjected to a post-CMP cleaning in a cleaning tool (e.g., a brush scrubber or a spin rinse dryer).

In some embodiments, the method that uses a polishing composition described herein can further include producing a semiconductor device from the substrate treated by the polishing composition through one or more steps. For example, photolithography, ion implantation, dry/wet etching, plasma ashing, deposition (e.g., PVD, CVD, ALD, ECD), wafer mounting, die cutting, packaging, and testing can be used to produce a semiconductor device from the substrate treated by the polishing composition described herein.

In one or more embodiments, this disclosure features a method of stabilizing a polishing composition. In some embodiments, the method can include mixing a polishing composition (e.g., a conventional polishing composition containing an abrasive) with at least one Si-containing compound that includes an acidic group, an ester thereof, or a salt thereof, such as the first Si-containing compound described herein.

The specific examples below are to be construed as merely illustrative, and not limitative of the remainder of the disclosure in any way whatsoever. Without further elaboration, it is believed that one skilled in the art can, based on the description herein, utilize the present invention to its fullest extent.

### EXAMPLES

In these examples, the polishing was performed on 200 mm wafers, using an AMAT Mirra CMP polisher, a Fujibo H804 pad, a downforce pressure of 1 psi, a platen head velocity of 71/63 rpm, and a slurry flow rate between of 175 mL/min and 225 mL/min.

The general compositions used in the examples are shown in Table 1 below. The specifics details on the differences in the compositions tested will be explained in further detail when discussing the respective examples.

TABLE 1

| | % By Weight |
|---|---|
| Component | of Composition |
| pH adjuster | 0.05-5 |
| First Si-Containing Compound (Organosilane | 0.005-1 (if used) |
| compound containing an acid group, an ester | |
| thereof, or a salt thereof) | |
| Organic Acid | 0.02-2 |
| Low-k Removal Rate Inhibitor | 0.01-1 |
| Azole-Containing Corrosion Inhibitor | 0.0001-0.1 |
| Abrasive (silica) | 0.1-12 |
| Oxidizer | 0.1-5 (if used) |
| Solvent (DI Water) | 80-99 |
| pH | 7-12 |

### Example 1

Table 2 below shows the Mean Particle Size (MPS) of silica particle solutions at different pH values when aged at 60°° C. for 10 days. This test simulates the ageing of polishing compositions and demonstrates their stability over time. At each pH value, a solution containing no organosilane compound was compared with a solution containing 1X organosilane compound and 3X organosilane compound.

TABLE 2

| | Organosilane | MPS @ | MPS @ | MPS @ | |
|---|---|---|---|---|---|
| | Compound | 0 Days | 2 days | 10 Days | % MPS |
| | (ppm) | (nm) | (nm) | (nm) | Increase |
| pH 2 | 0 | 68 | 78 | 98 | 44 |
| | 100 | 68 | 75 | 87 | 28 |
| | 300 | 68 | 70 | 72 | 6 |
| pH 3 | 0 | 69 | 110 | 290 | 320 |
| | 100 | 68 | 74 | 77 | 13 |
| | 300 | 68 | 74 | 74 | 9 |
| pH 4 | 0 | 70 | 126 | 387 | 453 |
| | 100 | 67 | 73 | 75 | 12 |
| | 300 | 68 | 74 | 75 | 10 |
| pH 5 | 0 | 68 | 70 | 76 | 12 |
| | 100 | 69 | 70 | 72 | 4 |
| | 300 | 72 | 74 | 75 | 4 |
| pH 6 | 0 | 70 | 71 | 71 | 1 |
| | 100 | 70 | 74 | 74 | 6 |
| | 300 | 74 | 76 | 76 | 3 |

The results show, surprisingly, that the inclusion of the organosilane compound significantly stabilized the silica solutions, particularly at pH values from 2-4 where the zeta potential values of the silica particles is near zero and commonly leads to significant particle aggregation over time. This result suggests that the inclusion of an organosilane compound to a polishing composition can unexpectedly result in a polishing composition that has a long and stable shelf life, which is an important consideration for end users of the polishing composition.

### Example 2

Table 3 below shows (1) the removal rate for Cu and TEOS blanket wafers when polished using Polishing Compositions 1-5 and (2) the Total Defect Counts (TDC) on the blanket wafers after the polishing. Total defect counts were measured using a KLA XUV Advanced Inspection Tool. Composition 1-5 were identical except that Compound 1 included no organosilane compound, Compositions 2 and 3 included an organosilane compound containing an acid group, an ester thereof, or a salt thereof, Composition 4 included an alkoxysilane compound, and Composition 5 included an aminosilane compound.

The results show that the inclusion of the organosilane compound containing an acid group, an ester thereof, or a salt thereof (i.e., Compositions 2 and 3) did not negatively affect the polishing performance of the compositions. Indeed, the removal rates of the TEOS and Cu films were relatively unchanged. Surprisingly, the inclusion of the organosilane compound containing an acid group, an ester thereof, or a salt thereof also significantly reduced the TDC on the polished TEOS wafers, with Composition 2 showing a ˜11% reduction in TDC and Composition 3 showing a ˜58% reduction in TDC when compared with Composition 1. Compositions 4 and 5 included an alkoxysilane compound and an aminosilane compound, respectively, and their use showed a significant increase in the TDC observed on Cu when compared with Compositions 1-3. The alkoxysilane compound and aminosilane compound used in Compositions 4 and 5 were compounds that did not contain an acid group, an ester thereof, or a salt thereof.

TABLE 3

| | Comp. 1 | Comp. 2 | Comp. 3 | | |
|---|---|---|---|---|---|
| | No | 100 ppm | 300 ppm | Comp. 4 | Comp. 5 |
| | Organo- | Organo- | Organo- | 300 ppm | 300 ppm |
| | silane | silane | silane | Alkoxy- | Amino- |
| | Compound | Compound | Compound | silane | silane |
| TEOS RR | 157 | 158 | 145 | 152 | 124 |
| (Å/min) | | | | | |
| Cu RR | 121 | 113 | 127 | 124 | 118 |
| (Å/min) | | | | | |
| TDC on | 291 | 236 | 68 | 138 | 84 |
| TEOS | | | | | |
| TDC on Cu | 50 | 68 | 75 | 278 | 308 |

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A polishing composition, comprising:
at least one abrasive;
at least one first Si-containing compound, the at least one Si-containing compound comprising an acidic group, an ester thereof, or a salt thereof; and
water;
wherein the at least one first Si-containing compound is not covalently bonded to the at least one abrasive.

2. The polishing composition of claim 1, wherein the abrasive is selected from the group consisting of alumina, silica, titania, ceria, zirconia, co-formed products of alumina, silica, titania, ceria, or zirconia, coated abrasives, surface modified abrasives, and mixtures thereof.

3. The polishing composition of claim 1, wherein the abrasive is in an amount of from about 0.1% to about 50% by weight of the composition.

4. The polishing composition of claim 1, wherein the at least one first Si-containing compound is selected from the group consisting of 3-(trihydroxysilyl) propyl methylphosphonate, 3-(trihydroxysilyl)-1-propanesulfonic acid, carboxyethylsilanetriol, (2-diethylphosphatoethyl)triethoxysilane, [3-(trihydroxysilyl) propyl](methyl) phosphate, 3-(trimethylsilyl)-1-propanesulfonic acid, 3-{[dimethyl (3-trimethoxysilyl)propyl]ammonio} propane-1-sulfonate, and combinations thereof.

5. The polishing composition of claim 1, wherein the at least one first Si-containing compound is in an amount of from about 0.0001% to about 20% by weight of the composition.

6. The polishing composition of claim 1, further comprising at least one second Si-containing compound different from the at least one first Si-containing compound.

7. The polishing composition of claim 6, wherein the at least one second Si-containing compound is selected from the group consisting of tetramethyl orthosilicate, tetraethyl orthosilicate, potassium methylsiliconate, (3-glycidyloxypropyl)trimethoxysilane, triethoxysilylpropoxy (polyethyleneoxy) dodecanoate, (3-triethoxysilyl)propylsuccinic anhydride, N-(2-aminoethyl)-3-aminopropyl-trimethoxysilane, ureidopropyltriethoxysilane, trimethylmethoxysilane, N-trimethoxysilylpropyl-N,N,N-trimethylammonium chloride, dimethyldimethoxysilane, vinyltrimethoxysilane, and potassium silicate.

8. The polishing composition of claim 6, wherein the at least one second Si-containing compound is in an amount of from about 0.0001% to about 10% by weight of the composition.

9. The polishing composition of claim 1, further comprising at least one organic acid or a salt thereof.

10. The polishing composition of claim 9, wherein the at least one organic acid of a salt thereof is selected from the group consisting of gluconic acid, lactic acid, citric acid, tartaric acid, malic acid, glycolic acid, malonic acid, formic acid, oxalic acid, acetic acid, propionic acid, peracetic acid, succinic acid, potassium acetate, potassium citrate, amino acetic acid, phenoxyacetic acid, bicine, diglycolic acid, glyceric acid, tricine, alanine, histidine, valine, phenylalanine, proline, glutamine, aspartic acid, glutamic acid, arginine, lysine, tyrosine, benzoic acid, 1,2-ethanedisulfonic acid, 4-amino-3-hydroxy-1-naphthalenesulfonic acid, 8-hydroxyquinoline-5-sulfonic acid, aminomethanesulfonic acid, benzenesulfonic acid, hydroxylamine O-sulfonic acid, methanesulfonic acid, m-xylene-4-sulfonic acid, poly(4-styrenesulfonic acid), polyanetholesulfonic acid, p-toluenesulfonic acid, trifluoromethane-sulfonic acid, ethyl phosphoric acid, cyanoethyl phosphoric acid, phenyl phosphoric acid, vinyl phosphoric acid, vinyl phosphonic acid, poly(vinylphosphonic acid), 1-hydroxyethane-1,1-diphosphonic acid, nitrilotri(methylphosphonic acid), diethylenetriaminepentakis (methylphosphonic acid), N,N,N′,N′-ethylenediaminetetrakis(methylene phosphonic acid), n-hexylphosphonic acid, benzylphosphonic acid, phenylphosphonic acid, ethylenediaminetetracetic acid, iminodiacetic acid, N-hydroxyethyl-ethylenediaminetriacetic acid, nitrilotriacetic acid, diethylenetriaminepentacetic acid, hydroxyethylethylenediaminetriacetic acid, triethylenetetraaminehexaacetic acid, diaminocycloheanetetraacetic acid, nitrilotrimethylphosphonic acid, ethylenediaminetetra(methylenephosphonic acid), 1-hydroxyl ethylidene-1,1,-diphosphonic acid, diethylenetriamine penta(methylene phosphonic acid), salts thereof, and mixtures thereof.

11. The polishing composition of claim 9, wherein the at least one organic acid or a salt thereof is in an amount of from about 0.02% to about 4% by weight of the composition.

12. The polishing composition of claim 1, further comprising:
at least one low-k removal rate inhibitor; and
at least one azole-containing corrosion inhibitor.

13. The polishing composition of claim 12, wherein the at least one low-k removal rate inhibitor comprises a nonionic surfactant.

14. The polishing composition of claim 13, where the nonionic surfactant is selected from the group consisting of alcohol alkoxylates, alkylphenol alkoxylates, tristyrylphenol alkoxylates, sorbitan ester alkoxylates, polyalkoxylates, polyalkylene oxide block copolymers, and alkoxylated diamines.

15. The polishing composition of claim 12, wherein the at least one low-k removal rate inhibitor is in an amount of from about 0.005% to about 5% by weight of the composition.

16. The polishing composition of claim 12, wherein the at least one azole-containing corrosion inhibitor is selected from the group consisting of triazole, tetrazole, benzotriazole, tolyltriazole, methyl benzotriazole, ethyl benzotriazole, propyl benzotriazole, butyl benzotriazole, pentyl benzotriazole, hexyl benzotriazole, dimethyl benzotriazole, chloro benzotriazole, dichloro benzotriazole, chloromethyl benzotriazole, chloroethyl benzotriazole, phenyl benzotriazole, benzyl benzotriazole, aminotriazole, aminobenzimidazole, pyrazole, imidazole, aminotetrazole, and mixtures thereof.

17. The polishing composition of claim 12, wherein the at least one azole-containing corrosion inhibitor is in an amount of from about 0.0001% to about 1% by weight of the composition.

18. The composition of claim 1, further comprising at least one pH adjuster.

19. The composition of claim 18, wherein the at least one pH adjuster is selected from the group consisting of inorganic bases, organic bases, and mixtures thereof.

20. The composition of claim 18, wherein the at least one pH adjuster is selected from the group consisting of ammonium hydroxide, sodium hydroxide, potassium hydroxide, cesium hydroxide, rubidium hydroxide, a quaternary ammonium hydroxide, a quaternary phosphonium hydroxide, and mixtures thereof.

21. The composition of claim 20, wherein the quaternary ammonium hydroxide or quaternary phosphonium hydroxide is selected from the group consisting of tetrabutylammonium hydroxide, ethyltrimethylammonium hydroxide, tetrapropylammonium hydroxide, tetraethylammonium hydroxide, tetramethylammonium hydroxide, diethyldimethylammonium hydroxide, dimethyldipropylammonium hydroxide, benzyltrimethylammonium hydroxide, tetramethylphosphonium hydroxide, tetraethylphosphonium hydroxide, tetrapropylphosphonium hydroxide, tetrabutylphosphonium hydroxide, tetrapentylphosphonium hydroxide, triethylmethylphosphonium hydroxide, tetrakis(hydroxymethyl)phosphonium hydroxide, tetraphenylphosphonium hydroxide, and any combinations thereof.

22. The polishing composition of claim 18, wherein the at least one pH adjuster is in an amount of from about 0.05% to about 10% by weight of the composition.

23. The polishing composition of claim 1, wherein the composition has a pH from about 2 to about 14.

24. A method of polishing a substrate, comprising the steps of:
applying the polishing composition of claim 1 to a surface of a substrate; and
bringing a pad into contact with the surface of the substrate and moving the pad in relation to the substrate.

25. A method of stabilizing a polishing composition, comprising mixing the polishing composition with at least one Si-containing compound;
wherein the polishing composition comprises an abrasive and the at least one Si-containing compound comprises an acidic group, an ester thereof, or a salt thereof.
